(19) United States
(12) Patent Application Publication
(10) Pub. No.: US 2014/0090039 A1
(43) Pub. Date: Mar. 27, 2014

(54) Secure System Access Using Mobile Biometric Devices

(71) Applicant: PLANTRONICS, INC., Santa Cruz, CA (US)

(72) Inventor: Gunjan Dhanesh Bhow, Menlo Park, CA (US)

(73) Assignee: PLANTRONICS, INC., Santa Cruz, CA (US)

(21) Appl. No.: 13/625,678

(22) Filed: Sep. 24, 2012

(51) Int. Cl. H04W 12/06

(52) U.S. Cl. 726/7

(57) ABSTRACT

Methods and apparatuses for secure system access are disclosed. In one example, a user request to access a secure system is received. A biometric user authentication request is transmitted to a user mobile device, and biometric data is obtained from the user. The user identity is authenticated utilizing the biometric data, and a response is transmitted from the mobile device to the secure system indicating the user identity is authenticated.

### BACKGROUND OF THE INVENTION

User authentication can be understood to be the act of proving to a computer-based system that a user is who she or he claims to be. User authentication is often described in terms of something you know (e.g., password), something you have (e.g. ATM card), or something you are (e.g., fingerprint). User authentication is the process of verifying one or more of these factors.

For example, a typical computer user is required to authenticate himself for a wide variety of purposes, such as logging in to a computer account, retrieving e-mail from servers, accessing certain files, databases, networks, web sites, etc. In banking applications, a bank account holder is required to enter a personal identification number (PIN) in order to access an automated teller machine (ATM) to conduct a banking transaction.

The main problem to be solved is authenticating in a convenient and secure way. For example, people often do financial transactions throughout the day on the Internet, and the inure convenient it is, the more likely they will buy things. The more secure it is, the more merchants and customers will use it. As another example, people often do security access throughout the day (e.g. passing through doors or accessing their computer). The easier it is to do these things, the more people can focus on the work at hand and not be distracted and frustrated by the inconvenience of repetitive interaction with security access.

Many systems for user authentication are available although none are completely satisfactory. For example, existing authentication solutions are usually one or two-factor and have a user do one or both of the following: a) Show, insert, or swipe a security token; b) Type a password, personal information or personal identification number (PIN), also called credentials.

An ATM transaction is an example of two-factor authentication. The ID card is inserted (factor 1) and a PIN (factor 2) is entered. This is considered more secure than online purchases because of the multiple factors. More recently for online transactions, ID cards can now display a temporary password that can be typed in after user name and password. This brings online transactions to two-factor security level as well.

Using tokens and/or passwords is both tedious and often not very secure. For example, others can see or overhear passwords, and steal credit cards and REID tags. A major problem is remembering multiple passwords and users are forced either to use the same password for all authentication systems (not secure) or forever recover/reset passwords as they become forgotten. Users may choose very simple, easily ascertained passwords, if a more difficult password is chosen, the user may write the password down, making it subject to theft. Furthermore a user is often required to fish a token out of a pocket or purse, which can be a major inconvenience in crowded or hurried situations.

As a result, improved methods and apparatuses for user authentication are needed.

### BRIEF DESCRIPTION OF THE DRAWINGS

The present invention will be readily understood by the following detailed description in conjunction with the accompanying drawings, wherein like reference numerals designate like structural elements.

FIG. 1 illustrates a system for user authentication in one example.

FIG. 2 illustrates a system for user authentication in a further example.

FIG. 3 illustrates a system for user authentication in a further example,

FIG. 4 illustrates a detailed view of the mobile and biometric input devices shown FIGS. 2 and 3 in one example.

FIG. 5 illustrates a detailed view of the mobile device shown in FIG. 1 in one example.

FIG. 6 illustrates authentication of a user to allow the user to access a secure system in the system shown in FIG. 1.

FIG. 7 illustrates authentication of a user to allow the user to access a secure system in the system shown in FIG. 2.

FIG. 8 illustrates authentication of a user to allow the user to access a secure system in a further example.

FIG. 9 is a flow diagram illustrating authenticating a user identity in one example.

FIG. 10 is a flow diagram illustrating authenticating a user identity in a further example.

FIG. 11 is a flow diagram illustrating authenticating a user identity in a further example.

### DESCRIPTION OF SPECIFIC EMBODIMENTS

Methods and apparatuses for secure system access are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

This invention relates to accessing secure systems using mobile biometric input devices. In one example, a method for authenticating a user includes receiving a user request to access a secure system, transmitting a biometric user authentication request to a user mobile device, and obtaining a biometric data from the user. The method further includes authenticating a user identity utilizing the biometric data, and transmitting a response from the mobile device to the secure system indicating the user identity is authenticated.

In one example, a computer readable storage memory stores instructions that when executed by a computer cause the computer to perform a method for user authentication. The method includes receiving a request from a secure system to authenticate a user, the user currently in communication with the secure system, transmitting a biometric user authentication request to a user mobile device, and receiving a user authentication confirmation from the user mobile device, the user authentication confirmation associated with a biometric user authentication. The method further includes responsive to receiving the user authentication confirmation from the user mobile device, transmitting a response to the secure system, the response configured to instruct the secure system to authenticate the user for an action at the secure system.

In one example, a computer readable storage memory storing instructions that when executed by a computer cause the computer to perform a method for user authentication including receiving a request from a remote device to authenticate a user, and transmitting a biometric user authentication request to a local wireless biometric input device. The method further includes receiving a user authentication confirmation, and responsive to receiving the user authentication confirmation from the local wireless biometric input device, transmitting a response to the remote device, the response operable to authenticate the user for a desired action.

In one example, a body worn fingerprint scanner is used to authenticate users. The fingerprint scanner may be in the form of a wrist watch or key fob The scanner includes a transmitter for wireless communication with a device such as a smartphone. It is powered by a low-power wireless technology such as Bluetooth. In certain examples, advantages include convenience for the user, the scanner can he used with virtually any secure system, and the use of low energy Bluetooth devices allow for longer use time.

In one implementation, a user wishes to log onto a website server, such as that of a financial institution. The website queries a user access server (e.g., a secure transaction server) over the Internet. The access server instructs the user's smartphone to authenticate the user. In a further example, a computer dongle is used. This connection may be over a cellular network or an IP based network. The user's smartphone instructs the scanner to receive the user's fingerprint. In one example, the scanner receives the fingerprint data from the user and authenticates the user at the scanner. In a further example, the scanner forwards raw fingerprint, data to the smartphone. An application on the smartphone analyzes the data and determines if the user's fingerprint is valid. The smartphone forwards the authentication data to the access server. The access server instructs the website to allow or deny access, such as to the user account.

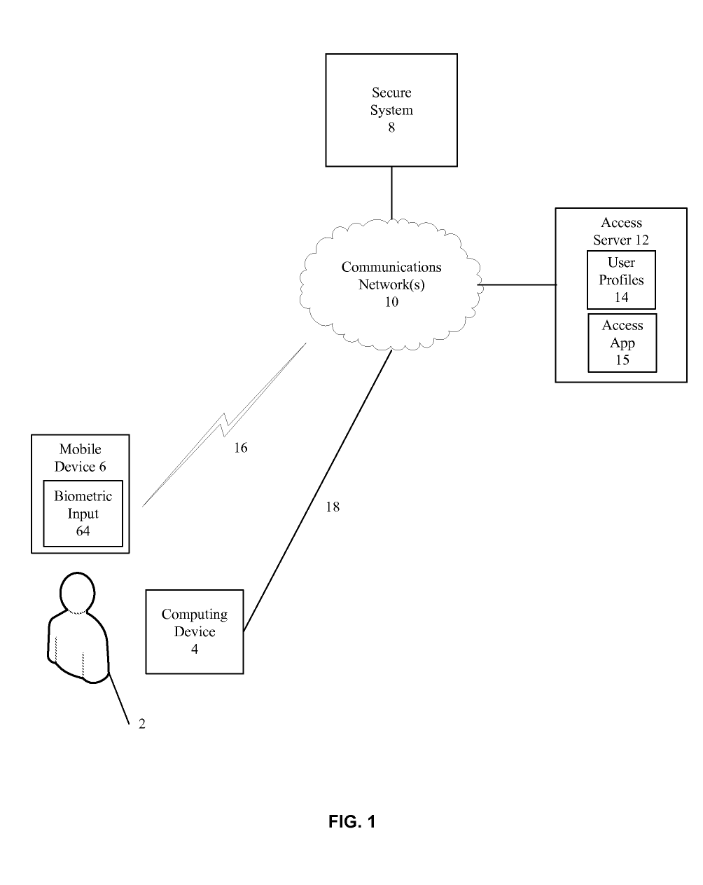

FIG. 1 illustrates a system for user authentication in one example. The system includes a computing device 4, mobile device 6, secure system 8, and access server 12 capable of communications therebetween via one or more communication network(s) 10. For example, communication network(s) 10 may include an Internet Protocol (IP) network, cellular communications network, public switched telephone network, IEEE 802.11 wireless network, or any combination thereof.

The computing device 4 and mobile device 6 are in proximity to a user 2 at a user 2 location. Mobile device 6 may, for example, be any mobile computing device, including without limitation a mobile phone, laptop, PDA, headset, tablet computer, or smartphone. The mobile device 6 includes a biometric input device 64 for authenticating the identity of user 2.

Secure system 8 may be any computer system which the user 2 wishes to access to perform a desired action. For example, secure system 8 may be a website such as a financial institution website at which user 2 wishes to access account information or perform a financial transaction. Such financial transactions may include transferring funds, sending payment, or purchasing stocks. For example, user authentication may be performed at a website, such as logging onto the website at first instance, or to make a purchase at the website.

Computing device 4 may be any device capable of communication with secure system 8 via communication network(s) 10 over network connection 18. For example, computing device 4 may be a desktop personal computer (PC), laptop computer, tablet computer, or smartphone. Network connection 18 may be a wired connection or wireless connection. In one example, network connection 18 is a wired or wireless connection to the Internet to access secure system 8. For example, computing device 4 includes a wireless transceiver to connect to an IP network via a wireless Access Point utilizing an IEEE 802.11 communications protocol. Similarly, network connection 16 may be a wired connection or wireless connection. In one example, network connection 16 is a wireless cellular communications link.

Access server 12 includes an access application 15 interfacing, with secure system 8 and mobile device 6 to authenticate the identity of user 2 to allow the user 2 to access secure system 8. In one example, access server 12 includes user profiles 14. User profiles 14 may store data associated with user 2 and other users, including contact information (e.g., mobile phone number or email address) for mobile device 6 for messaging user 2.

In operation, secure system 8 receives a request for access from user 2 operating computing device 4. Secure system 8 transmits a biometric user authentication request to access server 12 requesting that the user 2 identity be authenticated. Access application 15 retrieves user 2 contact information from user profiles 14 and transmits the biometric user authentication request to the user mobile device 6. User mobile device 6 receives the request over connection 16.

Mobile device 6 prompts user 2 for biometric data and receives the biometric data using biometric input device 64. Mobile device 6 authenticates the identity of user 2 and transmits a response to access server 12. Access server 12 notifies secure system 8 that the user 2 identity has been authenticated, and secure system 8 grants user 2 access to perform actions using computing device 4.

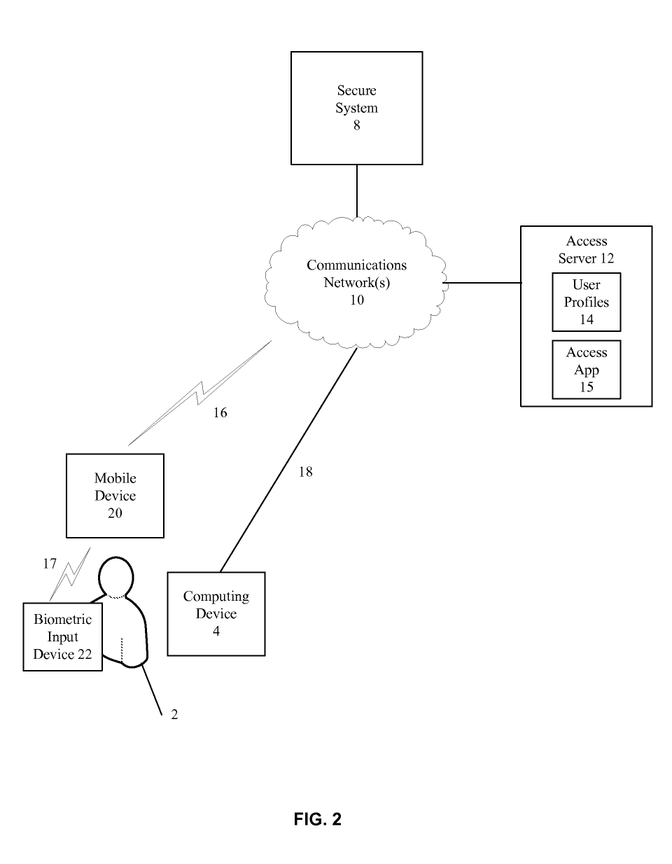

FIG. 2 illustrates a system for user authentication in a further example. The system shown in FIG. 2 operates substantially similar to that shown in FIG. 1 except that biometric data is obtained from user 2 utilizing mobile device 20 in conjunction with a biometric input device 22. Mobile device 20 may, for example, be a mobile phone, PDA, laptop, tablet device, smartphone, or any other device capable of performing functions described herein.

Mobile device 20 and biometric input device 22 include wireless transceivers configured for communication therebetween over wireless connection 17. In one example, biometric input device 22 is a body worn device. For example, biometric input device 22 may be a wrist-worn device or a headset. In a further example, biometric input device 22 is a body carried device, such as a key fob.

In operation, user mobile device 20 receives the user biometric authentication request over connection 16 from access server 12. Mobile device 20 prompts user 2 for biometric data, instructing user 2 to input biometric data at biometric input device 22. In one example, mobile device 20 receives the biometric data from biometric input device 22 and authenticates the identity of user 2 and transmits a response to access server 12.

In a further example, biometric input device 22 obtains the user 2 biometric data and authenticates the identity of user 2. Biometric input device 22 transmits an authentication confirmation to mobile device 20, which then transmits a response to access server 12.

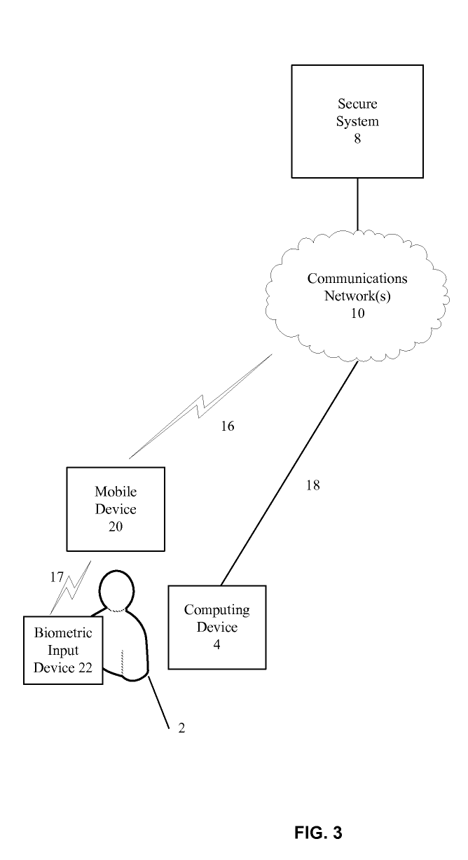

FIG. 3 illustrates a system for user authentication in a further example. The system shown in FIG. 3 operates substantially similar to that shown in FIG. 2 except that secure system 8 interfaces with mobile device 20 directly rather than via an access server. In the example shown in FIG. 3, secure system 8 transmits the biometric user authentication request to mobile device 20, Mobile device 20 transmits a response to secure system 8 indicating whether the user 2 identity has been authenticated.

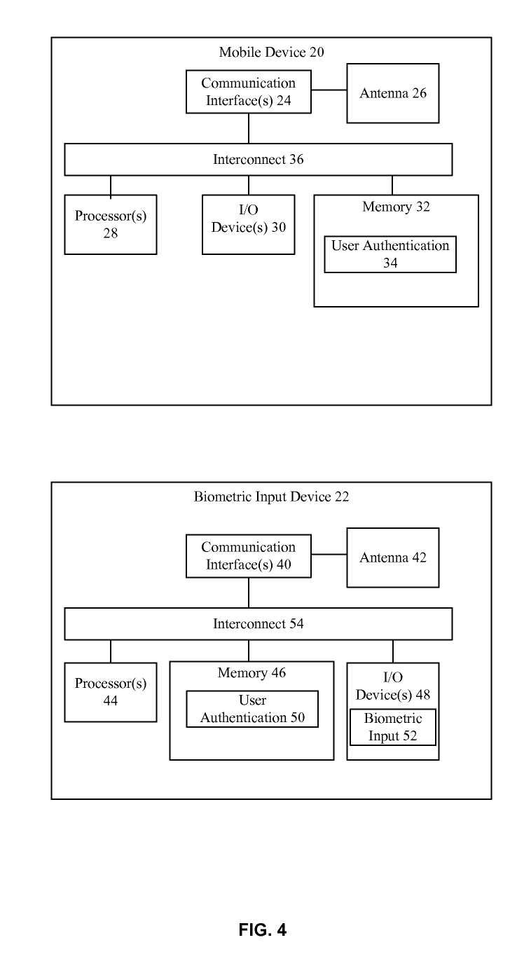

FIG. 4 illustrates a detailed view of the mobile and biometric input devices shown FIGS. 2 and 3 in one example. Simplified block diagrams of the mobile device 20 and biometric input device 22 are shown. In one example, the mobile device 20 and the biometric input device 22 each include a two-way RF communication device having data communication capabilities. The mobile device 20 and biometric input device 22 may have the capability to communicate with other computer systems via a local or wide area network.

Mobile device 20 includes input/output (I/O) device(s) 30 configured to interface with the user. I/O device(s) 30 may include input devices such as a microphone, keyboard, camera, touchscreen, etc., and one or more output devices, such as a display, speaker, etc. In some embodiments, I/O device(s) 30 may include or more of a display device, such as a liquid crystal display (LCD), an alphanumeric input device, such as a keyboard, and/or a cursor control device, and a biometric input device.

The mobile device 20 includes a processor 28 configured to execute code stored in a memory 32, Processor 28 executes a user authentication module 34 to perform user authentication functions described herein. In one example, user authentication module 34 is operable to interface with a user authentication module 50 at biometric input device 22 to confirm an identity of a user (i.e., authenticate the user).

While only a single processor 28 is shown, mobile device 20 may include multiple processors and/or co-processors, or one or more processors having multiple cores. The processor 28 and memory 32 may be provided on a single application-specific integrated circuit, or the processor 28 and the memory 32 may be provided in separate integrated circuits or other circuits configured to provide functionality for executing program instructions and storing program instructions and other data, respectively. Memory 32 also may be used to store temporary variables or other intermediate information during execution of instructions by processor 28. For example, memory may include pre-stored audio prompts for output through the device speaker which prompt the user to perform a biometric input, speak his name, speak a voice print phrase key, or speak or enter a password.

Mobile device 20 includes communication interface(s) 24, one or more of which may utilize an antenna 26. The communications interface(s) 24 may also include other processing means, such as a digital signal processor and local oscillators. In one example, communications interface(s) 24 include one or more short-range wireless communications subsystems which provide communication between mobile device 20 and different systems or devices, such as biometric input device 22. For example, the short-range communications subsystem may include an infrared device and associated circuit components for short-range communication, a near field communications (NIT) subsystem, a Bluetooth subsystem including a transceiver, or a WiFi subsystem. Interconnect 36 may communicate information between the various components of mobile device 20.

Memory 32 may include both volatile and non-volatile memory such as random access memory (RAM) and read-only memory (ROM). User authentication information, including personal identification numbers (PINs), fingerprint parameters and data, and voice print parameters and data, facial feature parameters, or other biometric data may be stored in memory 32.

Instructions may be provided to memory 32 from a storage device, such as a magnetic device, read-only memory, via a remote connection (e.g., over a network via communication interface(s) 24) that may be either wireless or wired providing access to one or more electronically accessible media. In alternative examples, hard-wired circuitry may be used in place of or in combination with software instructions, and execution of sequences of instructions is not limited to any specific combination of hardware circuitry and software instructions.

Mobile device 20 may include operating system code and specific applications code, which may be stored in non-volatile memory. For example the code may include drivers for the mobile device 20 and code for managing the drivers and a protocol stack for communicating with the communications interface(s) 24 which may include a receiver and a transmitter and is connected to an antenna 26. Communication interface(s) 24 provides a wireless interface for communication with biometric input device 22.

Communication interface(s) 24 may provide access to a network, such as a local area network. Communication interface(s) 24 may include, for example, a wireless network interface having antenna 26, which may represent one or more antenna(e). In one embodiment, communication interface(s) 24 may provide access to a local area network, for example, by conforming to IEEE 802.11b and/or IEEE 802.11 g standards, and/or the wireless network interface may provide access to a personal area network, for example, by conforming to Bluetooth standards. In addition to, or instead of communication via wireless LAN standards, communication interface(s) 24 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

Similarly, biometric input device 22 includes communication interface(s) 40, antenna 42, memory 46, and I/O device(s) 48 substantially similar to that described above for mobile device 20. Input/output (I/O) device(s) 48 are configured to interface with the user, and include a biometric input apparatus 52 operable to receive user biometric data. Memory 46 includes a user authentication module 50 to authenticate the identity of the user using biometric input apparatus 52 and interface with user authentication module 34 at mobile device 20. For example, biometric input apparatus 52 may be a fingerprint sensor operable to obtain user fingerprint data.

The biometric input device 22 includes an interconnect 54 to transfer data and a processor 44 is coupled to interconnect 54 to process data. The processor 44 may execute a number of applications that control basic operations, such as data and voice communications via the communication interface(s) 40. Processor 28 executes user authentication module 50.

In a further example, biometric input apparatus S2 may be a microphone configured to receive a user voice input and generate voice print data so that user authentication module 50 may perform a voice print match. A voice print match is highly accurate. In one example, the user voice input is a predetermined user provided identifying phrase (herein also referred to as the “voice print phrase key”). The voice print match may operate by matching the test voice print phrase key against a template of the authorized user's voice characteristics, such as spectral matching, cadence, etc. In one example, the user initially inputs a predetermined voice print phrase key or keys into the voice print identification system for use as the benchmark against which all future user accesses are compared. During the authentication process, the user must speak the predetermined voice print phrase key for comparison with the stored phrase. The user response must come within an acceptable range of similarity with the pre-stored voice print phrase key. The user may be prompted with audio prompts to speak the voice print phrase key.

In one example, the user voice input is a password input, and the user authentication module 50 is configured to authenticate an identity of the user by comparing the user voice input with a previously established password stored in the memory. In this example, the spoken user voice input is a fixed predetermined passphrase also referred to herein as a “password” or “personal identification number (PIN)” that only the device and the user know. The user may be prompted with a prestored audio prompt to speak the password or personal identification number. This passphrase is then received by the microphone, converted using an AID converter, and fed into a speech recognition (also sometimes referred to in the art as “voice recognition”) application to verify the correct phrase as spoken. Any speech recognition application/engine known in the art may be used. For example, the digitized voice samples are divided into frames of a pre-determined length. The energy of each frame is calculated and used to identify the start and end of a spoken word. Linear prediction coding may be used to produce parameters of the spoken word, and recognition features of the word are calculated and matched with reference words in a reference library. The submitted password or PIN recognized from the user speech is compared to the valid password or PIN to validate an identity of the authorized device user.

In a further example, biometric input apparatus 52 may be a fingerprint scanner configured to scan a user fingerprint so that user authentication module 50 may perform a fingerprint match. The biometric input device 22 includes a finger pad positioned on the exterior of the device housing in such a manner that at least a part of a fingerprint portion lies flat upon the finger pad during user authentication. The fingerprint scanner is properly aligned and integrated with the finger pad within the device housing. The fingerprint scanner may be an optical scanner or a capacitance scanner. In a further example, biometric input apparatus 53 may be an image recognition scanner, or camera, configured to scan a user's face, fingerprint, or retinal print and compare it with a previously stored version of the same to authenticate the user.

User authentication module 50 or user authentication module 34 includes a fingerprint feature identifier for analyzing scanned fingerprint scan data and a fingerprint match application for comparing the analyzed scanned fingerprint scan data to previously stored fingerprint data to uniquely identify a user. In a further example, biometric input apparatus 52 may be a facial recognition unit configured to scan a user face so that user authentication module 50 may perform a facial match. User biometric data may be stored in memory 46 for comparison.

In one example, user authentication module 50 does the following with respect to the authentication state of the user (1) takes in user specific data (password, fingerprint, facial image, retinal scan, or voiceprint biometrics hereafter called “credentials”), (2) analyzes credentials and determines authentication status, (3) records when a successful or failed authentication occurs, (4) monitors authentication expiration time for a given user, (5) revokes authentication under specified conditions or events. User authentication module 50 operates to examine user/password data or biometric data, and generates digital credentials based on this data. In one example, the user authentication module 50 has shared data or a database for its users and compares the digital credentials received to its data.

In a further example, functions described as being performed by user authentication module 50 at biometric input device 22 may be performed by user authentication module 34 at mobile device 20. For example, user authentication module 50 may take in user credentials and user authentication module 34 may analyze the credentials and determine authentication status. User authentication module 34 may operate to examine user/password data or biometric data, and generates digital credentials based on this data. In one example, the user authentication module 34 has shared data or a database for its users and compares the digital credentials received to its data

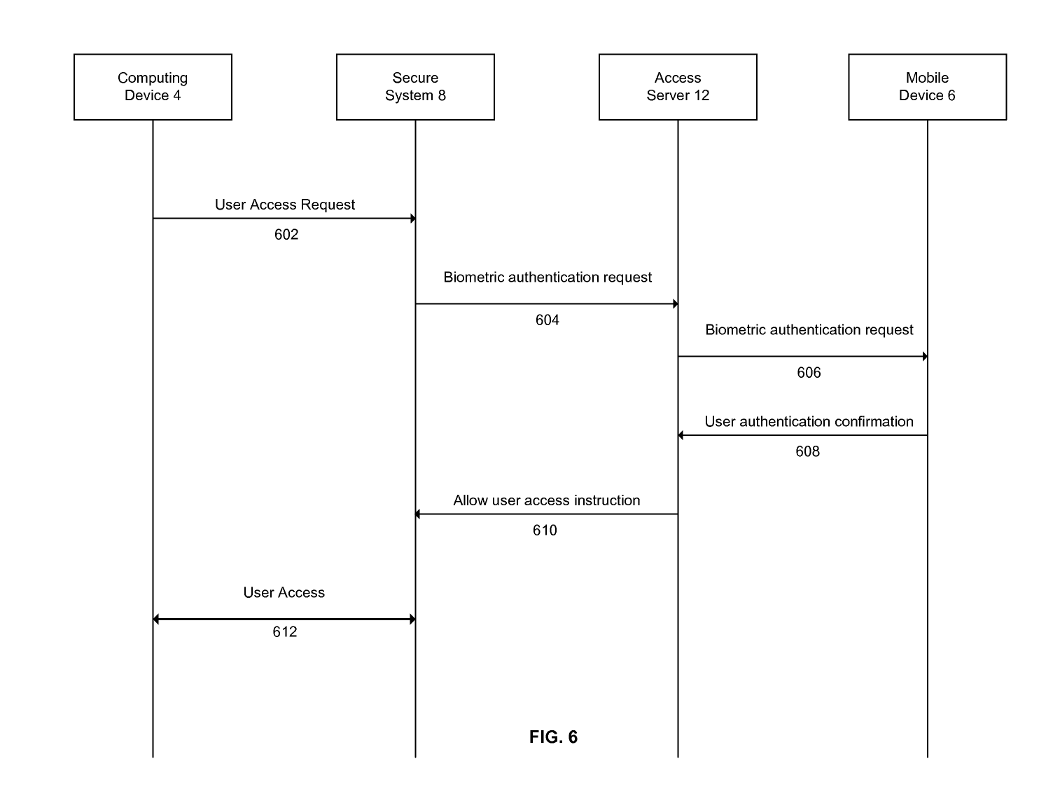

In further examples, I/O device(s) 48 may consist of a variety of devices which can be used to establish or authenticate the identity of a user. Users authenticate themselves using passwords, D-cards and/or biometrics to the authentication system through one or more I/O device(s) 48. Input is used to receive passwords and/or biometric data or read ID-cards. Output may display menu prompts. In various embodiments, the techniques of FIGS. 6-8 discussed below may be implemented as sequences of instructions executed by one or more electronic systems. The instructions may be stored by the mobile device 20 or the instructions may be received by the mobile device 20 (e.g., via a network connection) or stored by the biometric input device 22 or the instructions may be received by biometric input device 22, or the instructions may be stored or received by access server 12.

The specific design and implementation of the communications interfaces of the mobile device 20 and the biometric input device 22 are dependent upon the communication networks in which the devices are intended to operate. In one example, mobile device 20 and biometric input device 22 communicate with each other using a communication interface in accordance with the Bluetooth standard.

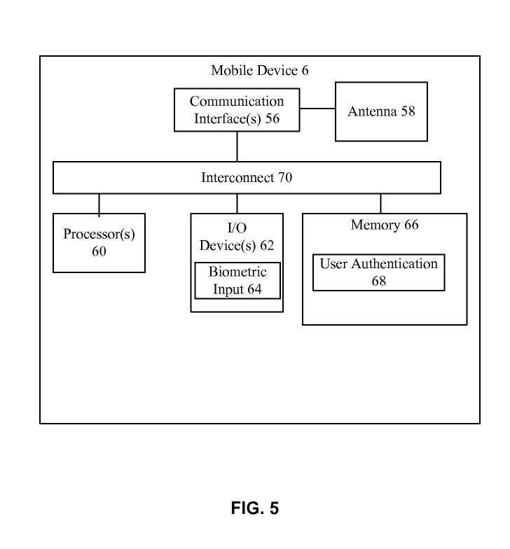

FIG. 5 illustrates a detailed view of the mobile device 6 shown in FIG. 1 in one example. Mobile device 6 is substantially similar to mobile device 20 and biometric input device 22, whereby the functionality of mobile device 20 and biometric input device 22 described above have been integrated into a single mobile device 6.

Mobile device 6 includes communication interface(s) 56, antenna 58, memory 66, and 110 device(s) 62. Input/output (110) device(s) 62 are configured to interface with the user, and include a biometric input apparatus 64 operable to receive user biometric data. Memory 66 includes a user authentication module 68 to authenticate the identity of the user using biometric input apparatus 64 and interface with access server 12 or secure system 8. For example, biometric input apparatus 64 may be a fingerprint scanner operable to scan user fingerprint data. Biometric input apparatus 64 may be similar to biometric input apparatus 52 described above.

The mobile device 6 includes an interconnect 54 to transfer data and a processor 60 is coupled to interconnect 54 to process data. The processor 60 may execute a number of applications that control basic operations, such as data and voice communications via the communication interface(s) 56. Processor 28 executes user authentication module 68, which may perform functions similar to user authentication module 50 and user authentication module 34 described above.

FIG. 6 illustrates authentication of a user to allow the user to access a secure system in the system shown in FIG. 1. At step 602, computing device 4 transmits a user access request to secure system 8. At step 604, secure system 8 transmits a biometric authentication request to access server 12. At step 606, access server 12 transmits a biometric authentication request to mobile device 6.

If the user identity is authenticated, at step 608, mobile device 6 transmits a user authentication confirmation to access server 12. At step 610, access server 12 transmits an allow user access instruction to secure system 8. At step 612, user access is granted between computing device 4 and secure system 8.

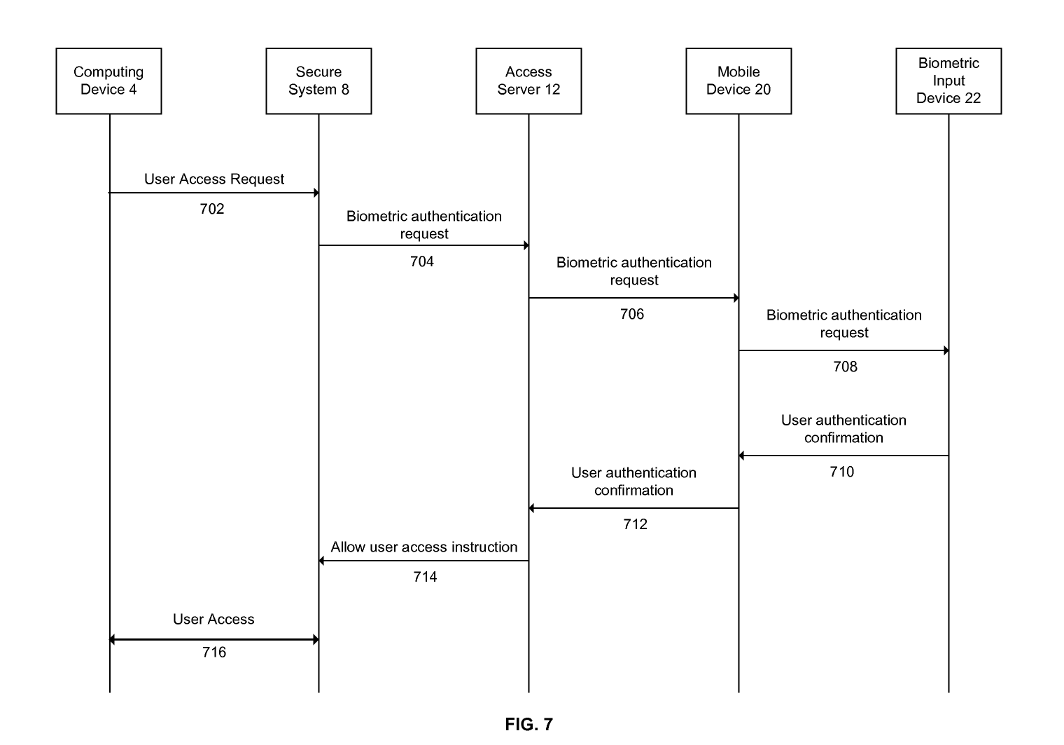

FIG. 7 illustrates authentication of a use to allow the user to access a secure system in the system shown in FIG. 2. At step 702, computing device 4 transmits a user access request to secure system 8. At step 704, secure system 8 transmits a biometric authentication request to access server 12. At step 706, access server 12 transmits a biometric authentication request to mobile device 20. A step 708, mobile device 20 transmits a biometric authentication request to biometric input device 22.

If the user identity is authenticated by biometric input device 22, at step 710, biometric input device 22 transmits a user authentication confirmation to mobile device 20. In a further example, biometric input device 22 transmits user biometric data to mobile device 20, and mobile device 20 processes the biometric data to authenticate the user identity. At step 712, mobile device 20 transmits a user authentication confirmation to access server 12. At step 714, access server 12 transmits an allow user access instruction to secure system 8. At step 716, user access is granted between computing device 4 and secure system 8.

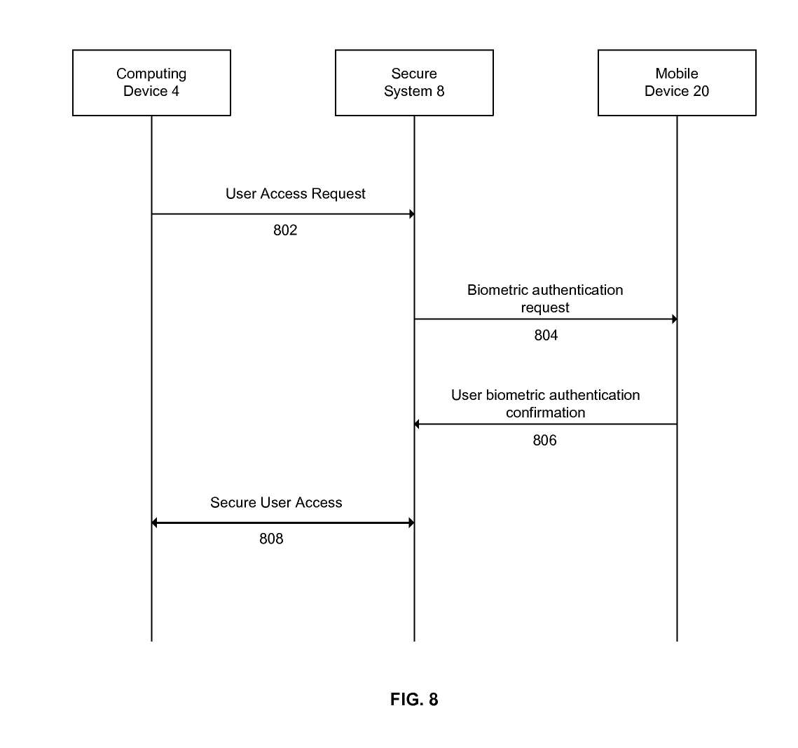

FIG. 8 illustrates authentication of a user to allow the user to access a secure system in a further example. At step 802, computing device 4 transmits a user access request to secure system 8. At step 804, secure system 8 transmits a biometric authentication request to mobile device 20. If the user identity is authenticated, at step 806, mobile device 20 transmits a user biometric authentication confirmation to secure system 8. At step 808, secure user access is granted between computing device 4 and secure system 8.

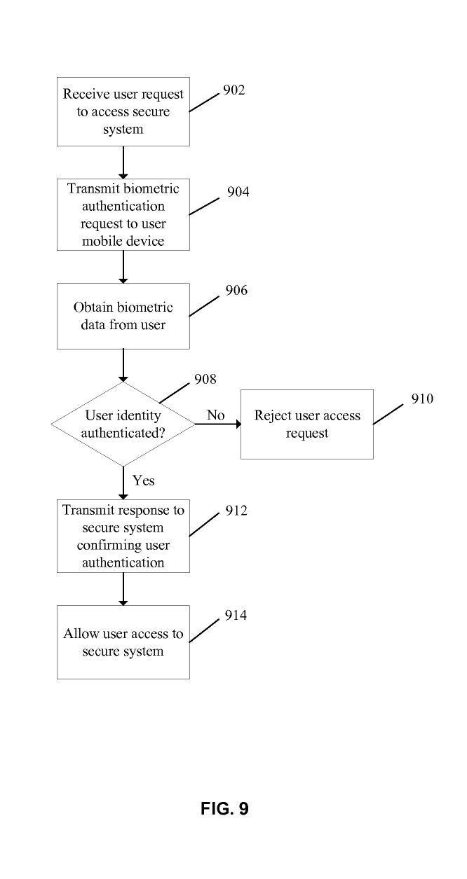

FIG. 9 is a flow diagram illustrating authenticating a user identity in one example. At block 902, a user request to access a secure system is received. In one example, the secure system is a website or a computer system.

At block 904, a biometric authentication request is transmitted to a user mobile device. In one example, the user mobile device is a mobile phone. In one example, transmitting a biometric user authentication request to a user mobile device includes transmitting the biometric user authentication request to a remote server, where the remote server transmits the biometric user authentication request to the user mobile device. The remote server may store a plurality of user profiles, the user profiles including a user mobile phone number or a user email address to which the biometric user authentication request is sent.

At block 906, biometric data is obtained from the user. In one example, the biometric data is obtained from the user at the user mobile device, the user mobile device including a biometric input device. In one example, the biometric data is obtained from the user at a biometric input device in wireless communication with the user mobile device. For example, the biometric device is a wrist worn device or a key fob.

At decision block 908 it is determined whether the user identity is authenticated. If no at decision block 908, the user access request is rejected at block 910. If yes at decision block 908, a response is transmitted to the secure system confirming user authentication at block 912. In one example, transmitting a response from the mobile device to the secure system indicating the user identity is authenticated includes transmitting the response to a remote server, where the remote server transmits the response to the secure system. At block 914, user access to the secure system is allowed.

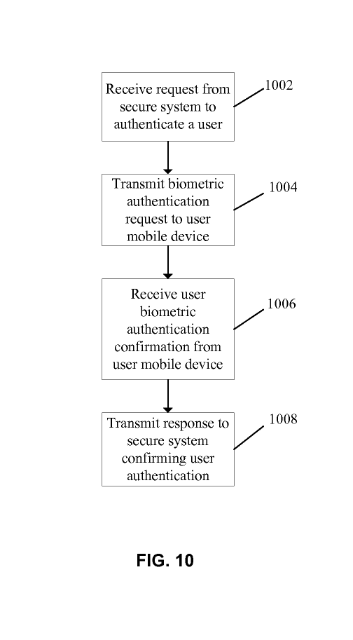

FIG. 10 is a flow diagram illustrating authenticating a user identity in a further example. At block 1002, a request is received from a secure system to authenticate a user. In one example, the secure system is a website. In one example, the request is received at a remote server, wherein the remote server transmits the biometric user authentication request to a user mobile device over a wireless network.

At block 1004, a biometric authentication request is transmitted to a user mobile device. In one example, the biometric user authentication request is configured to initiate a biometric user authentication process performed at the user mobile device. In a further example, the biometric user authentication request is configured to initiate a biometric user authentication process performed at a biometric input device in wireless communication with the user mobile device. For example, the biometric input device is a headset, wrist-worn device, or key fob, in one example, transmitting a biometric user authentication request to a user mobile device comprises sending via a wireless network a text message (e.g., a short message service (SMS) text or email).

At block 1006, a user biometric authentication confirmation is received from the user mobile device. At block 1008, a response is transmitted to the secure system confirming user authentication. If user biometric authentication confirmation is not received, a response is transmitted indicating that the user access request should be rejected.

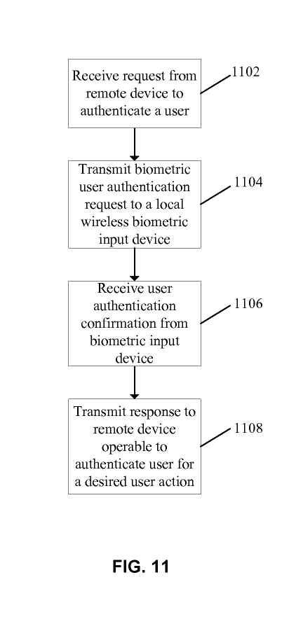

FIG. 11 is a flow diagram illustrating authenticating a user identity in a further example. At block 1102, a request is received from a remote device to authenticate a user. In one example, the request is received at a user mobile device. In one example, the request is responsive to a user desire to perform an action at a website. In one example, the remote device is a secure system or a server in communication with a secure system.

At block 1104, a biometric user authentication request is transmitted to a local wireless biometric input device. In one example, the local wireless biometric device is a fingerprint scanner disposed at a user body worn device. For example, the user body worn device is a wrist-worn device.

At block 1106, a user authentication confirmation is received from the biometric input device. In one example, the user authentication confirmation is received from the local wireless biometric input device, the local biometric input device obtaining a user biometric data and authenticating a user identity. In a further example, user biometric data is received from the local wireless biometric input device over a wireless network, and the biometric data is processed to authenticate a user identity. At block 1108, a response is transmitted to the remote device operable to authenticate the user for a desired user action. In one example, the desired action is at a website.

While the exemplary embodiments of the present invention are described and illustrated herein, it will be appreciated that they are merely illustrative and that modifications can be made to these embodiments without departing from the spirit and scope of the invention. Thus, the scope of the invention is intended to be defined only in terms of the following claims as may he amended, with each claim being expressly incorporated into this Description of Specific Embodiments as an embodiment of the invention.

What is claimed is:

1. A method for authenticating a user comprising:
receiving a user request to access a secure system;
transmitting a biometric user authentication request to a user mobile device;
obtaining a biometric data from the user;
authenticating a user identity utilizing the biometric data; and
transmitting a response from the user mobile device to the secure system indicating the user identity is authenticated.

2. The method of claim 1, wherein the secure system is an internet website.

3. The method of claim 1, wherein the secure system is a computer system.

4. The method of claim 1, wherein the user mobile device is a mobile phone.

5. The method of claim 1, wherein the biometric data is obtained from the user at the user mobile device, the user mobile device comprising a biometric input device.

6. The method of claim 1, wherein the biometric data is obtained from the user at a biometric input device in wireless communication with the user mobile device.

7. The method of claim 6, wherein the biometric input device is a wrist worn device or a key fob, a headset, or connected eye-glasses, or a finger-worn device

8. The method of claim I wherein the biometric user authentication request is received by the user mobile device over a wireless network.

9. The method of claim 1, wherein transmitting a biometric user authentication request to a user mobile device comprises transmitting the biometric user authentication request to a remote server, wherein the remote server transmits the biometric user authentication request to the user mobile device.

10. The method of claim 9, wherein the remote server comprises a plurality of user profiles, a user profile comprising a user mobile phone number or a user email address to which the biometric user authentication request is sent.

11. The method of claim 1, wherein transmitting a response from the mobile device to the secure system indicating the user identity is authenticated comprises transmitting the response to a remote server, wherein the remote server transmits the response to the secure system.

12. The method of claim 1, wherein the user request is received from a user computing device in proximity to the user mobile device.

13. A computer readable storage memory storing instructions that when executed by a computer cause the computer to perform a method for user authentication comprising:
receiving a request from a secure system to authenticate a user, the user currently in communication with the secure system;
transmitting a biometric user authentication request to a user mobile device;
receiving a user authentication confirmation from the user mobile device, the user authentication confirmation associated with a biometric user authentication; and
responsive to receiving the user authentication confirmation from the user mobile device, transmitting a response to the secure system, the response configured to instruct the secure system to authenticate the user for an action at the secure system.

14. The computer readable storage memory of claim 13, wherein the secure system comprises a website.

15. The computer readable storage memory of claim 13, wherein the request is received at a remote server, wherein the remote server transmits the biometric user authentication request to a user mobile device over a wireless network.

16. The computer readable storage memory of claim 13, wherein the biometric user authentication request is configured to initiate a biometric user authentication process performed at the user mobile device.

17. The computer readable storage memory of claim 13, wherein the biometric user authentication request is configured to initiate a biometric User authentication process performed at a biometric input device in wireless communication with the user Mobile device.

18. The computer readable storage memory of claim 17, wherein the biometric input device is a headset, wrist-worn device, or key fob.

19. The computer readable storage memory of claim 13, wherein transmitting a biometric user authentication request to a user Mobile device comprises sending;
via a wireless network a text message.

20. A computer readable storage memory storing instructions that when executed by a computer cause the computer to perform a method for user authentication comprising:
receiving a request from a remote device to authenticate a user;
transmitting a biometric user authentication request to a local wireless biometric input device;
receiving a user authentication confirmation; and
responsive to receiving the user authentication confirmation, transmitting a response to the remote device, the response operable to authenticate the user for a desired action.

21. The computer readable storage memory of claim 20, wherein the request is received at a user mobile device.

22. The computer readable storage memory of claim 20, wherein the local wireless biometric input device is a fingerprint scanner disposed at a user body worn device.

23. The computer readable storage memory of claim 22, wherein the user body worn device is a wrist-worn device.

24. The computer readable storage memory of claim 20, wherein the request is responsive to a user desire to perform an action at a website.

25. The computer readable storage memory of claim 20, wherein the desired action is at a website.

26. The computer readable storage memory of claim 20, wherein the remote device is a secure system.

27. The computer readable storage memory of claim 20, wherein the remote device is a server in communication with a secure system.

28. The computer readable storage memory of claim 20, wherein the user authentication confirmation is received from the local wireless biometric input device, the local wireless biometric input device obtaining a user biometric data and authenticating a user identity.

29. The computer readable storage memory of claim 20, further comprising:
receiving a user biometric data from the local wireless biometric input device over a wireless network; and
processing the biometric data to authenticate a user identity.
